(19) United States
(12) Patent Application Publication
(10) Pub. No.: US 2014/0218837 A1
(43) Pub. Date: Aug. 7, 2014

(54) Fast transfer electro-mechanical relay

(71) Applicant: Nilo Villarin, Great Falls, VA (US)

(72) Inventor: Nilo Villarin, Great Falls, VA (US)

(21) Appl. No.: 13/385,952

(22) Filed: Mar. 17, 2012

Related U.S. Application Data
(60) Provisional application No. 61/465,397, filed on Mar. 18, 2011.

(51) Int. Cl. H01H 47/22

(52) U.S. Cl. CPC H01H 47/22
USPC 361/160

(57) ABSTRACT

This invention provides an electromechanical transfer switch having a transfer time sufficiently fast, less than 20 milliseconds, as to allow computer based equipment to ride through a power interruption without shutdown. The transfer switch utilizes relatively slow acting, high amperage, electromechanical power relays that have been modified by replacing the relay armature spring with a higher tension substitute and applying overdrive voltage to the relays.

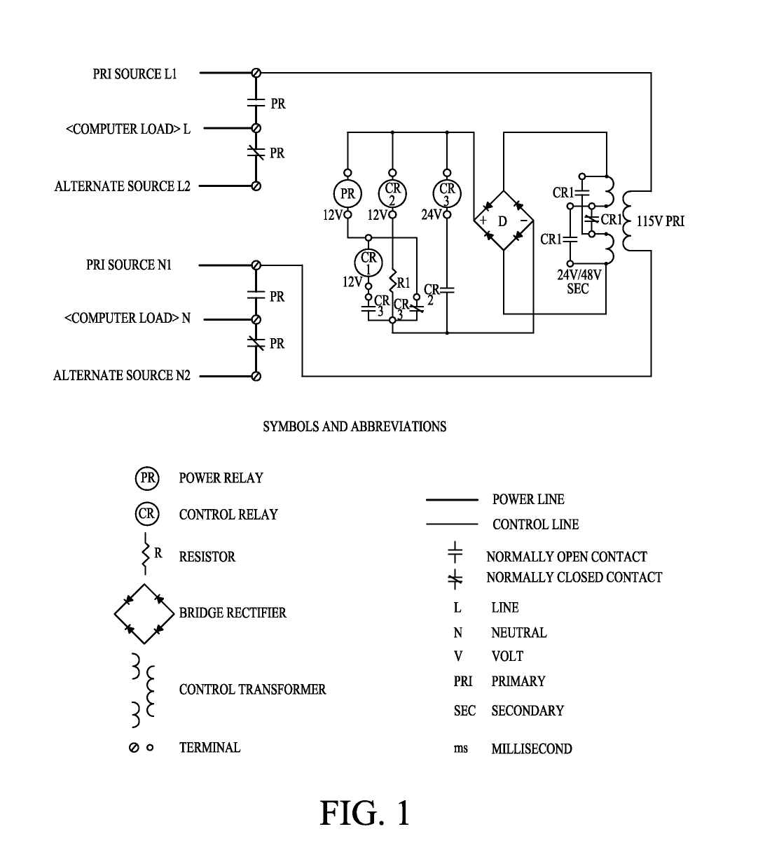

### REFERENCE TO RELATED APPLICATION

This application claims the benefit of U.S. Provisional Patent Application No. 61/465,397 which was filed on Mar. 18, 2011.

### BACKGROUND OF THE INVENTION

1. Technical Field

This invention relates generally to a transfer relay for use with computer based equipment that switches automatically and seamlessly from a primary power source to a secondary power source upon interruption or failure of the primary source.

More specifically, this invention relates to a means for accelerating transfer times of a relatively slow acting, high amperage, electromechanical power relay in order to achieve transfer times of 20 milliseconds or less as transfer times greater than about 20 milliseconds may result in computer shut down.

2. Description of Related Art

Electromechanical power relays are well known in the art and are widely commercially available. Such relays do not need and do not achieve the rapid transfer times, e.g., less than 20 milliseconds, that are required for use with computer based equipment. Maximum transfer times for computer based equipment to ride through a momentary power interruption, as recommended by the Information Technology Industry Council, ITI, (formerly Computer and Business Manufacturer's Association, CBEMA,) is 20 milliseconds or less.

According to the Engineers' Relay Handbook, the method of coil overdrive, i.e. temporarily applying a multiple of pickup voltage to the device, is a technique that has been used for two mechanically interlinked contactors designed as a dropout switch where dropout times are not a concern. However, when coil overdrive in used on a conventional relay the dropout time remains unchanged and retransfer travel time could exceed 20 milliseconds.

Systems to restore electrical power to a load that includes computer based equipment in the event of source failure are in common use. Such systems necessarily include a primary and a secondary power source and a means to switch from the primary to the secondary source in case of disruption or failure of the primary source. Those systems are often complex and expensive. One example of a backup power system is illustrated by U.S. Pat. No. 5,579,197. Another power failure transfer switching system is described in U.S. Pat. No. 5,903.065 and includes a battery operated control circuit having a time delay relay which slows the transfer from the primary to a secondary power source. Yet another switching system is illustrated by applicant's prior patent, U.S. Pat. No. 6,639,330.

### SUMMARY OF THE INVENTION

The transfer time of a relatively slow acting, high amperage relay is decreased by replacing the relay armature return spring with another spring having a significantly higher tension while also overdriving the relay coil by increasing the applied voltage to the coil. The modified relays are employed in an automatic transfer switch to obtain transfer times substantially less than 20 milliseconds.

### BRIEF DESCRIPTION OF THE DRAWING

The sole FIGURE is a schematic diagram that illustrates a preferred embodiment of the invention.

### DESCRIPTION OF PREFERRED EMBODIMENTS OF THE INVENTION

This invention provides a method and means for reducing the transfer time of a conventional electromechanical relay to achieve transfer times sufficiently rapid to avoid computer shut down when transferring from a primary to a backup power supply. That is accomplished through modification of a conventional relay by replacing the relay armature return spring with a spring having a tension substantially higher than what would normally be used for the particular relay and thereafter applying an overdrive voltage to the relay coil to activate the relay.

The purpose of the high spring tension is to accelerate relay dropout and the replacement spring tension is selected so that, when the rated armature voltage is applied, the relay pickup will be delayed or will not pick up. However, there is a limit to spring tension increase because, as the spring tension is increased, the dropout becomes faster but the pickup becomes slower. Application of an overdrive voltage to the relay coil serves to overcome the delayed pickup and the combination of increased spring tension and overdrive voltage results in the relay achieving transfer times of 20 milliseconds or less.

Referring now to the FIGURE, there is illustrated the sequence of operation of the modified fast transfer relay explaining how the rapid transfer times are accomplished. The pickup and dropout times of the first and second supplementary control relays (CR1 and CR2) are essential to ensuring fast switching operation of the power relay PR.

Sequence of operation is as follows. Initially, with the control transformer de-energized, the secondary transformer coil is connected in series to obtain a 48 volt output through the contacts of CR1. Resistor R1 is shorted by the normally closed contact of the third control relay CR3. Application of 115 volts to the control transformer results in a 48 volt dc output, which is about 5 times the power relay pickup voltage. That will overdrive the coil and accelerate the relay pickup. The same 48 volts will be impressed on CR2. Control relays CR1, CR2, and CR3s are in cascade, i.e., operate in sequence to ensure that the power relay PR picks up first before the pickup of CR1.

As soon as CR2 picks up, its normally open contact closes, energizing CR3. Form C contacts of CR3 simultaneously power up CR1 and remove the bypass across resistor R1. CR1 contacts reconnect the control transformer secondary to 24 volts ac and impress rated dc voltages to the relays. The brief interruption of power during this switching operation will not cause PR to drop out. R1 limits the voltage across CR1, CR2 and PR to their rated voltages of approximately 12 volts. Loss of the primary power source L1 will cause PR to drop out in less than 20 milliseconds as a result of its high armature spring tension. Power is then seamlessly supplied to the load by way of alternate power source L2.

It can be appreciated from the foregoing description that this invention provides a simple and rugged electromechanical transfer switch that operates quickly enough to avoid computer shut down upon loss of a primary power source and its replacement with a secondary source of power.

I claim:

1. A method for enhancing the performance of a relatively slow acting, high amperage electromechanical power relay to achieve transfer times sufficiently rapid to serve as a transfer relay for use with computer based equipment to automatically switch from a primary power source to a secondary power source without computer shutdown upon interruption or failure of the primary source, comprising;
providing a conventional electromechanical power relay, said relay having a coil and transformer means to apply a voltage to the coil, thereby activating the relay by movement of an armature working against an armature return spring;
replacing the armature return spring with a spring having a sufficiently greater spring tension to accelerate relay dropout; and
modifying the transformer means so as to apply a higher overdrive voltage to the coil to accelerate relay pickup, said replacement spring tension and overdrive voltage selected to achieve transfer times of less than 20 milliseconds.

2. The method of claim 1 wherein the overdrive voltage applied to the relay coil is at least about 5 times the pickup voltage of the relay.
